(19) United States
(12) Patent Application Publication
(10) Pub. No.: US 2005/0188987 A1
(43) Pub. Date: Sep. 1, 2005

(54) Subcompact modular ionic breath cleaner

(76) Inventor: Peter Siltex Yuen, San Jose, CA (US)

Correspondence Address: Yuen, Peter Siltex, 2765 Henessy Drive, San Jose, CA, 95148, US

(21) Appl. No.: 10/791,471

(22) Filed: Mar. 1, 2004

(51) Int. Cl. B03C 3/68

(52) U.S. Cl. 128/202.25

(57) ABSTRACT

A subcompact modular ionic breath cleaner consists of a subcompact breath cleaner ionization module which has ionization element and voltage multiplier PCBA enclosed in a very small housing for user to hang it around the neck, and a waist belt mounting power supply module. The ionization module is as small as a match box and receives power from a waist belt carrying power supply module through a connection cable. The minimized weight and size will make users to feel comfortable to wear in almost any occasion. The waist belt carrying concept shifts the heavier components to the belt with enough battery power for users on long trips. This invention offsets all the heavy load of transformer and batteries from an integrated single unit air cleaner into a supper light weight ionization module with a reasonable power supply duration.

### FIELD OF INVENTION

The present invention relates to ionic air filtration system especially for removing air-borne matters in human breath, and more particularly, a subcompact modular breath cleaning device.

### BACKGROUND OF THE INVENTION

Ionic air cleaners are commonly used in homes and offices. The technology has been widely accepted and proven. Personal ionic air cleaners for body wearing are also available and are welcomed by travelers riding on subways, trains and airplanes where air-borne contagious deceases are easily transmitted.

However, the currently available body-wearing ionic cleaners are bulky. Every one is packaged in housing enclosing all the essential components within a single unit. All the batteries, transformer, PCBA, ionization element subassembly and the whole works are assembled into the unit. As results, the final packaging becomes a quite sizable unit hanging around the user's neck and resting in front of the user's chest.

It is not uncommon for an air trip to take over 24 hours for indirect flight these days. The air cleaner will be more ideal to be able to support operation for at least 24 hours or even better be 40 hours before battery changes. This makes wearing a conventional air cleaner in front of the chest very uncomfortable.

Secondly, even with today's highly efficient electronic components, it still requires about 0.5 watt of input power to drive the air cleaner in order to keep the air quality surrounds the user's face relatively clean and odor free. A 9 volt alkaline battery usually cannot last for 5 hours. Therefore, a small ionic air cleaner with 40 hours service time will be a relatively heavy unit when hanging around the neck of the user.

Thus there is a need for an ionic air cleaner to be very light weight such that it is comfortable for wearing around the neck and hanging in front of the chest of the user while providing enough power to ionize the surrounding air of the user's face in order to keep the air quality to be always at an acceptable level for an extended period of operation between battery changes.

The present invention provides such a body wearing subcompact modular breath cleaning device for user to enjoy.

### CROSS REFERENCE TO RELATED APPLICATIONS

Field of Search
International Class: A62B 23/00, 7/10

US Class 128/200.24; 96/29, 54, 69, 71, 72, 75, 78, 97, 98, 100

U.S. Patent Documents

| 4549887 | Oct 29, 1985 | Joannou | 96/58 |
|---|---|---|---|
| | This is not a human breath cleaning device. | | |
| 5042997 | Aug 27, 1991 | Rhodes | 96/18 |
| | This is not a human body carrying electronic breath | | |
| | cleaning system. | | |
| 5232478 | Aug 3, 1993 | Farris | 96/26 |
| | This is not a human body carrying electronic breath | | |
| | cleaning system. | | |
| 5573577 | Nov 12, 1996 | Joannou | 96/66 |
| | This is not a human body carrying electronic breath | | |
| | cleaning system. | | |
| 5690720 | Nov 25, 1995 | Spero | 96/26 |
| | This is not a human body carrying electronic breath | | |
| | cleaning system. | | |
| 5846302 | Dec 8, 1998 | Putro | 96/66 |
| | This is not a human body carrying electronic breath | | |
| | cleaning system. | | |
| 6245132 | June 12, 2001 | Feldman | 96/28 |
| | This is not a human body carrying electronic breath | | |
| | cleaning system. | | |
| 6497754 | Dec 24, 2002 | Joannou | 96/67 |

This is not a human body carrying electronic breath
cleaning system.

### SUMMARY OF THE INVENTION

A subcompact modular ionic breath cleaner consists of a subcompact human wearable light weight ionization module with built-in ionization element and multiplier circuit electronic function, and a power supply module designed for belt carrying. The ionization module receives high oscillating voltage input and transforms the input into output of a very high voltage potential capable to support ionization at the ionization element.

The unique feature of this invention is to redefine a bulky conventional ionic air cleaner into a very compact ionization module with a cable connection to a main power supply module, which includes all the batteries, transformer and the basic PCBA, the switch and indicator light etc. The subcompact ionization module includes the multiplier electronic components and the ionization element subassembly. In this design, the heavier main unit can be clipped to the waist belt of the user while the subcompact ionization module will be supported by a strap around the shoulder/neck of the user.

It is an object of this present invention to provide a very compact, comfortable with reasonable power output and long service period between battery changes ionic breath cleaner for today's busy travelers.

Other features and advantages of the invention will appear from the following description in which the preferred embodiments have been set forth in detail, in conjunction with the accompanying drawings.

### BRIEF DESCRIPTION OF THE DRAWINGS

FIG. 1 is the overall diagram of the modular body wearing subcompact ionic breath cleaner with the subcompact breath cleaner ionization module and the power supply module. It depicts a portion of the subcompact breath cleaner ionization module, a portion of the neck strap, a portion of the electrical connector, a portion of the connection cable with strain relief, a portion of the main power supply module and a user wearing the device to demonstrate the relative usage of the system with a portion of the conceptual clean air pocket according to present invention.

FIG. 2 illustrates the front view of the subcompact ionization module, which depicts a portion of the module cover with cut out to show components inside, a portion of the hanger extension, a portion of the ionization element module, a portion of the encapsulated voltage multiplier PCBA, a portion of the collector plate, a portion of the collector cover, a portion of the connectors, strain relief, portion of ionized air streams through the slot openings, a portion of the air passage opening and a portion of the conceptual clean air pocket according to present invention.

FIG. 3 is the electronic circuit diagram of the modular body wearing subcompact ionic breath cleaner with the voltage multiplier circuit integrated into the subcompact breath cleaner ionization module and with connectors connecting its input source to the output of the transformer of the main power supply module.

FIG. 4 illustrates the front view of an alternative concept of the subcompact ionization module, which depicts a portion of the module cover with cut out to show components inside, a portion of the hanger extension, a portion of the ionization element module, a portion of the collector plate, a portion of the collector cover, a portion of the connectors, strain relief, portion of ionized air streams through the slot openings, a portion of the air passage opening and a portion of the conceptual clean air pocket according to present invention.

FIG. 5 is the electronic circuit diagram of the modular body wearing subcompact ionic breath cleaner without the voltage multiplier circuit integrated into the subcompact breath cleaner ionization module. It corresponds to the FIG. 4 alternative concept of the subcompact ionization module with the ionization element input connecting its input source to the output of the voltage multiplier of the main power supply module.

### DETAILED DESCRIPTION OF THE PREFERRED EMBODIMENT

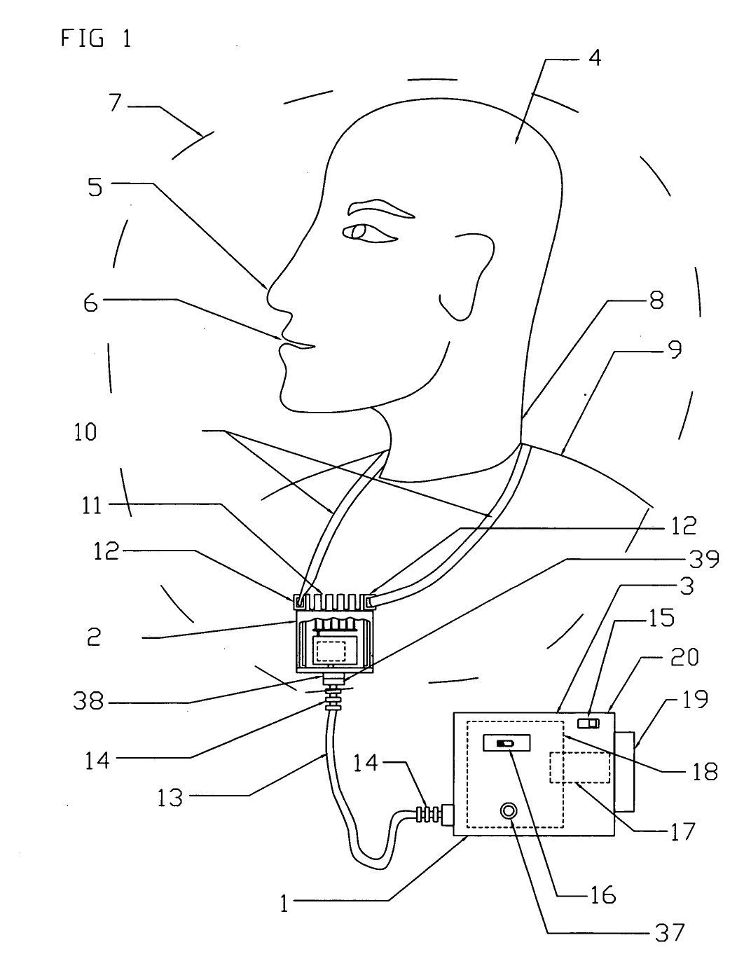

FIG. 1 is the overall diagram of the body wearing personal subcompact modular ionic breath cleaner 1 with a subcompact ionization module 2 being supported around the shoulder 9 of the user 4 with the neck strap 10 connected to the two hanger extensions 12 of the subcompact ionization module 2.

The subcompact ionization module 2 is equipped with an electrical connector 38, which is connected to a mating connector 39 of the main power supply unit 3 via the connector cable 13 with strain relief 14 at both ends of the connector cable 13. The main power supply module 3 is consisted of battery 17 as the power source, main PCBA 18, status indicator 16, power switch 15, power-charger connector 37 inside the housing 20 and belt mounting clip 19 which provide mounting means to the waist belt of the user 4.

The battery 17 provides power to the PCBA 18 which is consisted of electronic components and transformer to provide oscillating voltage power supply through the cable 13, mating connector 39 and electrical connector 38 to the subcompact ionization module 2. The subcompact ionization module 2 ionizes the surrounding air through at least one slot opening 11 and forms a conceptual cleaner air pocket 7, which has better air quality with much less air borne matters than ambient surrounding the face of the user.

The electrical connector 38 allows the subcompact ionization module 2 to be easily disconnected from the mating connector 39 of the cable 13 of the main power supply module 3.

The subcompact ionization module 2 is equipped with at least one hanger extension 12, which provides attachment support for the neck strap 10. The illustration of FIG. 1 shows 2 hanger extensions. The neck strap 10 is made of flexible material. It can be molded rubber, silicon rubber, cloth, nylon, string, chain or any other material/object that can facilitate the functions of a neck strap.

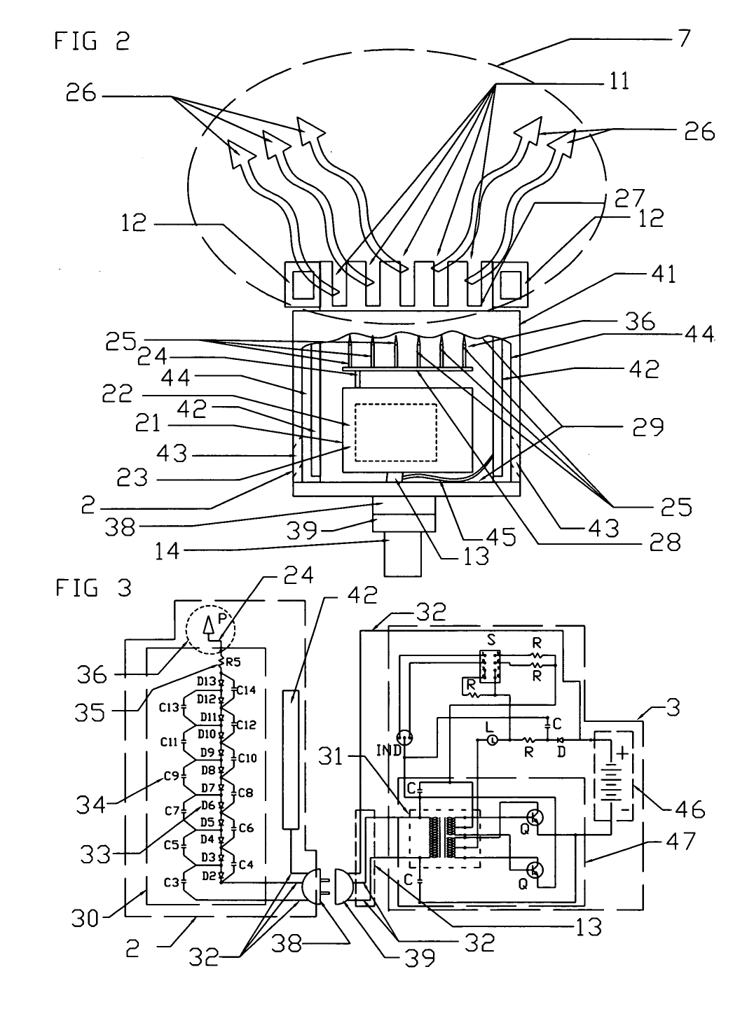

FIG. 2 illustrates the front view of the subcompact ionization module 2, which is equipped with encapsulated PCBA 21 supported by the inside of the module cover 27. A collector plate 42 is supported by the external surface of the module cover 27. This collector plate 42 is electrically connected to cable 13 and through electrical means 45 eventually connected to the (+) positive pole of the input power supply. The collector cover 41 is supported by the module cover 27 covers the surface of the collector plate 42 with an air passage 44 space in between. Collector cover 41 is equipped with at least one passage opening 43, which allows air and ionic charged matters to flow through from the ambient to the surface of the collector plate 42. The collector cover 41 can be easily removed by user such that collector plate 42 is accessible for cleaning and can have more than one passage opening, or can also be perforated with lot of passage opening 43 over the entire surface.

The cut out 29 cuts through collector plate 42, collector cover 41 and module cover 27 exposing the internal components of the ionization module 2. The module cover 27 can be made of plastic or metal.

The encapsulated PCBA 21 is comprised of multiplier PCBA 22 molded inside the encapsulation compound (resin) 23, which protects the multiplier PCBA 22 from external shorting of the electrical circuits. The input of the multiplier PCBA 22 is connected to the electrical connector 38 through cable 13. The output of the multiplier PCBA 22 is connected to the ionization element 36 through connecting lead 24. The multiplier PCBA 22 can be composed of conventional through holes electronic components, surface mounted technology (SMT) components, chip on board technology components or combination of these components. The SMT components as well as the chip on board technology components allow the PCBA 22 to be smaller in physical size and the encapsulation prevents the components to be shorted due to small distances between conductive leads of different voltage potentials. It results that the physical form factor of the PCBA 22 can be minimized.

The encapsulated PCBA 21 and the ionization element 36 are supported by the module cover 27. The ionization element 36 comprises of needle base 28 and at least one ionization needle 25. There are six ionization needles 25 shown in FIG. 2. The needle base 28 can be made of metal or PCB, which can facilitate the mounting supports for the ionization needle 25 and the electrical conductivity from the output of the encapsulate PCBA 21 to the needle 25 via the connecting lead 24.

In practice, the multiplier PCBA 22 receives high oscillating voltage at its input and transforms it into much higher electrical potential functions at the output. The output is then transmitted to the ionization element 36. The ionization needle 25 of the ionization element 36 will then produce high levels of negative ions. These negative-ion-generators cause electrons to be added to molecules of Oxygen, Nitrogen and other trace gases in the surrounding ambient air forming ionized air stream 26 through the slot opening 11. As results, a concentration of these charged molecules of gases fills the ambient surrounding of the slot opening 11 and exhibits a cleaner air pocket 7 environment surrounding the ionization module 2. This process creates ions with a negative charge. When the ions become negatively charged, they collide with airborne pollutants such as pollen, mold spores, dust, bacteria, tobacco smoke, saliva moisture, sneeze moisture and many other airborne particles. The negative charge of ion is then transferred to the airborne particles. Surrounding this newly negatively charged particle are many other particles that are positively charged. These positively charged particles will adhere to the negatively charged particles and eventually become too heavy to be airborne and drop off from the air stream.

The physical size of the subcompact ionization module 2 is governed by the number of ionization needles 25 and the size of the encapsulated PCBA 21. With the use of SMT components, chip on board technology components and encapsulation as insulator between components, the form factor of the subcompact ionization module 2 can be optimized to the smallest dimensions. It results that a well designed subcompact ionization module 2 can be as small as a match box weighing about couple of ounces and most users will find that to be very comfortable to wear; especially when comparing to a complete personal ionic air cleaner with batteries and transformer hanging around the neck. Furthermore, a reasonable personal ionic air and breath cleaner should have a reasonable cleaning power output and reasonable battery power duration. These basic requirements will make a complete well non-modular designed personal ionic breath and air cleaner very awkward to wear by hanging around the neck 8. However, with this subcompact ionization modular concept, a well designed personal modular ionic breath/air cleaner 1 can be divided into a main power supplying module 3 and a subcompact ionization module 2 linked together with cable 13. Users will find it to be very comfortable with heavy main power supplying module 3 mounted onto the waist belt and just the small and light subcompact ionization module 2 being supported by the neck 8/shoulder 9 portion of the body.

FIG. 3 is the electronic circuit diagram of the modular ionic breath cleaner. The high voltage power supply source of the main power supply module 3 connects to the voltage multiplier 30 of the subcompact ionization module 2 through electrical connector 38 and mating connector 39. A low voltage battery 46 supplies power to an oscillator stage circuit 47. The output is then stepped-up by transformer (T1) 31, which in turn feeds the input of voltage to the voltage multiplier 30. The high voltage output from the voltage multiplier 30 is then sent to the ionization element 36 where ionization occurs.

The voltage multiplier 30 can be comprised of electronic components with any combination of capacitor 34, diode 33, resistor 35 and IC 40 that can facilitate the function of voltage multiplying. The oscillating output of the transformer 31 is connected to the mating connector 39 through the conductor leads 32 of the cable 13; and is then transmitted to electrical connector 38 when connector 38 is connected to mating connector 39. This oscillating output is transmitted to the input of the voltage multiplier 30 through conductor leads 32. The voltage multiplier 30 then magnifies the voltage to high enough output voltage for supporting the ionization process at the ionization element 36.

The (+) positive pole of the battery power supply 46 is connected to the mating connector 39 via conductor lead 32 of cable 13; and is then connected to electrical connector 38 when connector 38 is connected to mating connector 39. The collector plate 42 of the subcompact ionization module 2 is connected to the (+) positive pole of the battery power supply 46 through conductor lead 32 connecting to electrical connector 38. This modular personal ionic breath cleaner 1 is a full function ionization filtration system with power supplied by the main power supply module 3, ionization charging at subcompact ionization module 2 and charged airborne matters collection by the collector plate 42.

Experiment shows 8 AA (2000 mAH) NiMH rechargeable batteries can support operation of a modular personal ionic breath cleaner 1 prototype device for over 24 hours.

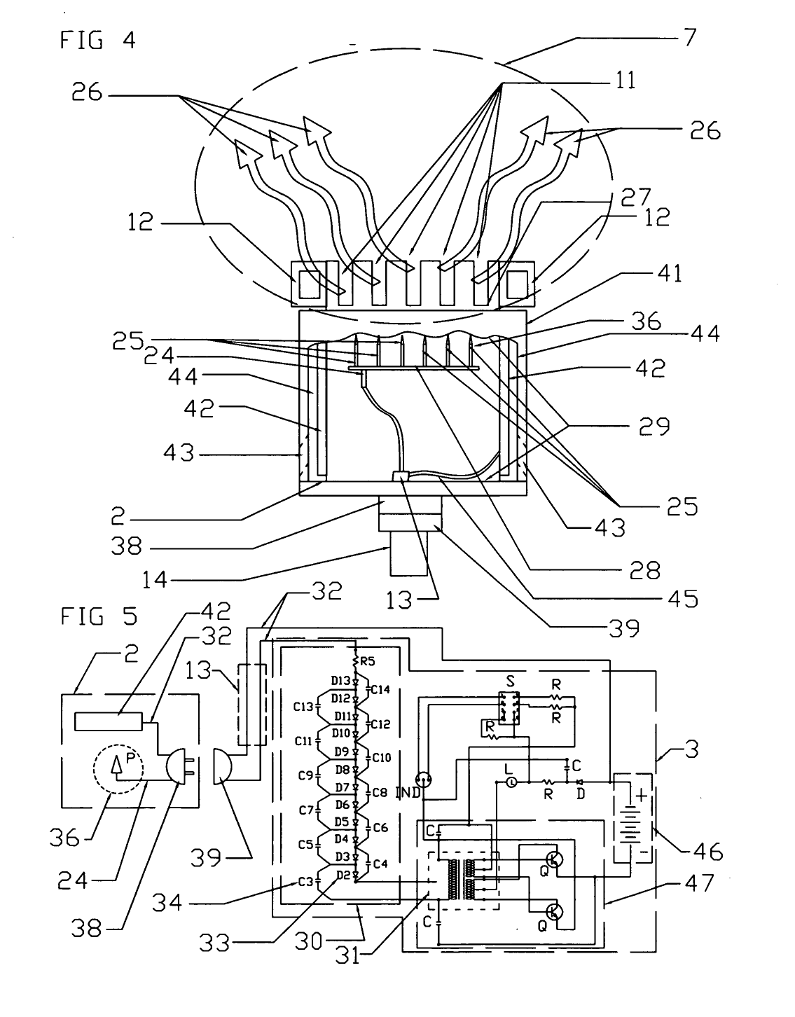

FIG. 4 illustrates the front view of the alternative concept of the subcompact ionization module 2, which is equipped with module cover 27. A collector plate 42 is supported by the external surface of the module cover 27. This collector plate 42 is electrically connected to cable 13 and through electrical means 45 eventually connected to the (+) positive pole of the input power supply. The collector cover 41 is supported by the module cover 27 covers the surface of the collector plate 42 with an air passage 44 space in between. Collector cover 41 is equipped with at least one passage opening 43, which allows air and ionic charged matters to flow through from the ambient to the surface of the collector plate 42, which provides an adhesion surface for the oppositely charged airborne matters to adhere to. It results that the ionic charged air passing over the surface of the collector plate 42 will have much less airborne substances and considered as much cleaner in air quality. The collector cover 41 can be easily removed by user such that the collector plate 42 is accessible for cleaning and can have more than one passage opening or even be perforated with passage opening 43 over the entire surface.

The cut out 29 cuts through collector plate 42, collector cover 41 and module cover 27 exposing the internal components of the ionization module 2. The module cover 27 can be made of plastic or metal.

The ionization element 36 is supported by the module cover 27 and is connected through connecting lead 24 to the electrical connector 38 through cable 13. The ionization element 36 comprises of needle base 28 and at least one ionization needle 25. There are six ionization needles 25 shown in FIG. 2. The needle base 28 can be made of metal or PCB, which can facilitate the mounting supports for the ionization needle 25 and the electrical conductivity from the high voltage input to the needle 25.

The ionization needle 25 produces high levels of negative ions when high voltage is applied to it. These negative-ion-generators cause electrons to be added to molecules of Oxygen, Nitrogen and other trace gases in the surrounding ambient air forming ionized air stream 26 through the slot opening 11. As results, a concentration of these charged molecules of gases fills the ambient surrounding of slot opening 11 and exhibits a cleaner air pocket 7 environment surrounding the ionization module 2. This process creates ions with a negative charge. When the ions become negatively charged, they collide with airborne pollutants such as pollen, mold spores, dust, bacteria, tobacco smoke, saliva moisture, sneeze moisture and many other airborne particles. The negative charge of ion is then transferred to the airborne particles. Surrounding this newly negatively charged particle are many other particles that are positively charged. These positively charged particles will adhere to the negatively charged particles and eventually become too heavy to be airborne and drop off from the air stream.

The physical size of the subcompact ionization module 2 is governed by the number of ionization needles 25 and the form factor of the subcompact ionization module 2 can now be optimized to the smallest dimensions. It results that a well designed subcompact ionization module 2 can be as small as a match box weighing about couple of ounces and most users will find that to be very comfortable to wear; especially when comparing to a complete personal ionic breath/air cleaner with batteries and transformer hanging around the neck. Furthermore, a reasonable personal ionic breath cleaner should have a reasonable cleaning power output and reasonable battery power duration. These basic requirements will make a complete well designed personal ionic breath/air cleaner very awkward to wear by hanging around the neck 8. However, with this subcompact ionization module 2 concept, a well designed personal subcompact modular ionic breath/air cleaner 1 can be divided into a main power supplying module 3 and a subcompact ionization module 2 linked together with a cable 13. Users will find it to be very comfortable with heavy main power supplying module 3 mounted onto the waist belt and just the small and light subcompact ionization module 2 supported by the neck 8/shoulder 9 portion of the body.

FIG. 5 is the electronic circuit diagram of the subcompact modular ionic breath cleaner 1 corresponding to the alternative concept stated in FIG. 4. The voltage multiplier 30 circuit is integrated into the power supply module 3. The high voltage power supply source of the main power supply module 3 with its output becomes the output of the voltage multiplier 30. This output is connected to the input of the subcompact ionization module 2 through cable 13, electrical connector 38 and mating connector 39. A low voltage battery 46 supplies power to an oscillator stage circuit 47. The output of the oscillator stage circuit 47 is then stepped-up by transformer (T1) 31, which in turn feeds the input of voltage to the voltage multiplier 30. The high voltage output from the voltage multiplier 30 is then eventually sent to final designation, which is the ionization element 36 of the subcompact ionization module 2, where ionization occurs.

The output of the voltage multiplier 30 of the main per supply module 3 is connected to the mating connector 39 through the conductor leads 32 of the cable 13; and is then transmitted to electrical connector 38 when connector 38 is connected to mating connector 39. This high voltage output is transmitted to ionization element 36 through connecting lead 24. The high voltage potential supports the ionization process at the ionization element 36.

The (+) positive pole of the battery power supply 46 is connected to the mating connector 39 via conductor lead 32 of cable 13; and is then connected to electrical connector 38 when connector 38 is connected into mating connector 39. This collector plate 42 of the subcompact ionization module 2 is eventually connected to the (+) positive pole of the battery power supply 46 through conductor lead 32 connecting to electrical connector 38 and cable 13. Collector plate 42 provides an adhesion surface for the oppositely charged airborne matters to adhere to. It results that the ionic charged air passing over the surface of the collector plate 42 will have much less airborne substances and be considered as much cleaner in air quality. This modular personal ionic breath cleaner 1 is a full function ionization filtration system with power supplied by the main power supply module 3, ionization charging at subcompact ionization module 2 and charged airborne matters collection by the collector plate 42.

Experiment shows 8 AA (2000 mAH) NIMH rechargeable batteries can support operation of a modular personal ionic breath cleaner 1 prototype device for over 24 hours.

It will be appreciated that the sizes, quantities, shapes and dispositions of various components like ionization element, hanger extensions, conductor leads, wires, cable length, material use, slot opening size, type of connectors and size can be varied, without departing from the spirit and scope of the invention. Similarly, the sizes and shapes of the housing, collector plate, collector cover and the like may be varied. While the methods of connecting the neck strap of the cable are illustrated, other methods may instead be used to facilitate the concept of neck strap. While the method of mounting ionization element at the top concept is illustrated, other directions, relative locations and methods may instead be used to facilitate the concept of mounting the ionization element to the final system.

Modifications and variations may be made to the disclosed embodiments without departing from the subject and spirit of the invention as defined by the following claims.

1. A subcompact modular ionic breath cleaner is a human body carrying air cleaner for reducing airborne substances in the air surrounding the user's face comprised of
A subcompact breath cleaner ionization module with an electrical input means;
A main power supply module which provides power source for the said subcompact breath cleaner ionization module with an electrical output means;
A connecting cable with a first electrical coupling means at one end and a second electrical coupling means at the other end;
The said first electrical coupling means of the said connecting cable is connected to the said input of the said subcompact breath cleaner ionization module;
The said second electrical coupling means of the said connecting cable is connected to the said output of the said main power supply module.

2. The apparatus of claim 1, wherein said the said subcompact breath cleaner ionization module is a portable human body carrying device that supplies electrical ionic charges to air molecules surrounding the face of the user when high voltage is supplied to the electrical input of the said compact breath cleaner ionization module comprised of
A housing enclosure with mechanical mounting means;
A conducting collector cover supported by the said housing enclosure;
An encapsulated PCBA (printed circuit board assembly) which having an input and an output, is supported by the said housing enclosure;
A conducting collector element which is made of electrically conductive material having an input is supported by the said housing enclosure;
A third electrical coupling means for receiving an electric potential from a high voltage source which is the said output of the said encapsulated PCBA;
An ionizing element comprising an electrically conductive material having needle-pointed ends for providing a high potential gradient to ionize particle components of a gas passing there-through said ionizing element being connected to the said third electrical coupling means to produce said high potential gradient when supplied with charge from a high voltage source through said third electrical coupling means.
A fourth electrical coupling means which is the said electrical input means of the said subcompact breath cleaner ionization module, is electrically connected to the said input of the encapsulated PCBA and is supported by the said housing enclosure;
A slot opening allows air and ionic charges to travel freely between the said ionizing element and the outside ambient of the housing enclosure;
A mechanical coupling means assembled to the said mechanical mounting means of the said housing enclosure to provide carrying means of the said subcompact breath cleaner ionization module for the said user.

3. The apparatus of claim 2, wherein said the said encapsulated PCBA comprises of a PCBA encapsulated in encapsulation resin to allow the spaces between components to be smaller and will not be electrically shorted.

4. The apparatus of claim 3, wherein said the encapsulation protects the PCBA from shorting due to foreign conductive matters, which includes conductive fluid, metal and solid with conductive surfaces.

5. The apparatus of claim 3, wherein said the method of using encapsulation with encapsulation resin process on the components of the PCBA of a compact breath cleaner ionization module.

6. The apparatus of claim 3, wherein said the said encapsulation resin is a plastic material which can be injection molded.

7. The apparatus of claim 3, wherein said the said encapsulation resin is a carbon base material.

8. The apparatus of claim 3, wherein said the said encapsulation resin is a silicon base material.

9. The apparatus of claim 3, wherein said the said PCBA utilizes surface mount technology (SMT) components to minimize the physical size of the said PCBA.

10. The apparatus of claim 9, wherein said the method of utilizing surface mount technology (SMT) components to minimize the physical size of the PCBA of a subcompact breath cleaner ionization module.

11. The apparatus of claim 3, wherein said the said PCBA utilizes chip on board technology components to minimize the physical size of the said PCBA.

12. The apparatus of claim 1 wherein said the method of utilizing chip on board technology components to minimize the physical size of the PCBA of a subcompact breath cleaner ionization module.

13. The apparatus of claim 3, wherein said the said PCBA comprises of electronic components which provide voltage multiplier functions having an input and an output with the said output forms an output of high voltage power supply to the said ionizing element to ionize particle components of a gas passing there-through the said ionizing element when the said input is supplied with a high oscillating voltage.

14. The apparatus of claim 13, wherein said the said voltage multiplier functions magnify the input voltage by at least 50% at the said output.

15. The apparatus of claim 13, wherein said the said output of high voltage power supply to the said ionizing element is at least 5000 volt.

16. The apparatus of claim 2, wherein said the said conductive collector element attracts the airborne charged matters introduced by the said ionization process with the said input of the said conductive collector element is connected to a source with opposite electrically charged with reference to the electrical polarity of the said ionizing element.

17. The apparatus of claim 16, wherein said the method of using a conductive collector element to attract airborne charged matters introduced by ionization process with the said input of the said conductive collector element is connected to a source with opposite electrically charged with reference to the electrical polarity of the said ionizing element, in a subcompact breath cleaner ionization module.

18. The apparatus of claim 2, wherein said the said ionizing element generates positive ionic charges.

19. The apparatus of claim 2, wherein said the said ionizing element generates negative ionic charges.

20. The apparatus of claim 1, wherein said the said conductor cable has a section of the cable processed into coil form.

21. The apparatus of claim 2, wherein said the said fourth electrical coupling means is a quick disconnect connector which is defined as disconnecting process without requirement of removal of mechanical fastener.

22. The apparatus of claim 2, wherein said the said electrically conductive material having needle-pointed ends may be substituted with conductive metal-coated fine non-metallic filaments.

23. The apparatus of claim 2, wherein said the method of using an ionizing element in a human body carrying subcompact breath cleaner ionization module to ionize particle components of a gas passing there-through the said ionizing element.

24. The apparatus of claim 23, wherein said the said ionizing element generates positive ionic charges.

25. The apparatus of claim 23, wherein said the said ionizing element generates negative ionic charges.

26. The apparatus of claim 1, wherein said the said main power supply module of a subcompact modular ionic breath cleaner which supplies high voltage source to the said subcompact breath cleaner ionization module to ionize particle components of a gas passing there-through the ionizing element of the said subcompact breath cleaner ionization module is comprised of
A housing enclosure;
A belt mounting mechanism support by the said housing enclosure for user's belt mounting;
A battery holder having an output and is supported by the said housing provides space for the battery as the power source for the said subcompact modular ionic breath cleaner;
A PCBA (printed circuit board assembly) having an input and an output with the said input connected to the said output of the said battery holder is functioned to transform the said battery power into high voltage source at the said output;
A fifth electrical coupling means connected to the said output of the said PCBA for accepting the said second electrical coupling means of the said connecting cable for the transmission of electric potential energy all the way to the said input of the subcompact breath cleaner ionization module;
A power on-off switch;
A sixth electrical coupling means connected to the said PCBA and serves as the receptacle for external power supply;
An indicating means connected to the said PCBA and supported by the said housing enclosure for the indication of the power status of the system.

27. The apparatus of claim 26, wherein said the said PCBA of the said power supply module of a subcompact modular ionic breath cleaner comprises:
A direct current DC power supply stage;
An oscillator stage powered by said direct current power supply;
A step-up transformer having a primary and at least one secondary winding, said primary winding forming an output of said oscillator stage;
The said output of the said oscillator stage is the said output of the said power supply module.

28. The apparatus of claim 27 wherein said the method of using an oscillator circuit to convert a DC power source into a pulsating/oscillating DC power source as the input power source to a step-up transformer circuit of a high voltage power supply source of a power supply module of a subcompact modular ionic breath cleaner.

29. The apparatus of claim 27 wherein said the method of using a step-up transformer with at least one primary winding and at least one secondary winding to transform a pulsating/oscillating DC power source input to a higher voltage output of a high voltage power supply source of a power supply module of a subcompact modular ionic breath cleaner.

30. The apparatus of claim 13 wherein said the method of using a voltage multiplier circuit to multiply the input voltage of an oscillating voltage to a high voltage output as a high voltage power supply source of an ionization process of a subcompact breath cleaner ionization module.
The voltage multiplier circuit is defined as using multiple stages of capacitor and diode cascade circuit to increase the said input voltage to an output voltage of at least 1 time of the said input voltage potential.

31. The apparatus of claim 13 wherein said the electronic components of the said voltage multiplier PCBA are encapsulated in encapsulation resin to allow the spaces between components to be smaller and will not be electrically shorted.

32. The apparatus of claim 31 wherein said the method of using encapsulation with encapsulation resin process on the components of the PCBA of a subcompact breath cleaner ionization module of a subcompact modular ionic breath cleaner.

33. The apparatus of claim 2 wherein said the mechanical coupling means is a neck strap for hanging the said subcompact breath cleaner ionization module to the front of the user's body by wearing the said neck strap around the user's neck.

34. The apparatus of claim 33 wherein said the neck strap is a soft and flexible object.

35. The apparatus of claim 2 wherein said the mechanical coupling means is a mechanical clip for mounting the said subcompact breath cleaner ionization module to the front of the user's body by clipping the said mechanical clip to the cloth of the user.

36. The apparatus of claim 1, wherein said the said subcompact breath cleaner ionization module is a portable human body carrying device that supplies electrical ionic charges to air molecules surrounding the face of the user when high voltage is supplied to the electrical input of the said compact breath cleaner ionization module comprised of
A housing enclosure with mechanical mounting means;
A conducting collector cover supported by the said housing enclosure;
A conducting collector element which is made of electrically conductive material having an input is supported by the said housing enclosure;
A seventh electrical coupling means for receiving an electric potential from a high voltage source which is the input of the said subcompact breath cleaner ionization module;
An ionizing element comprising an electrically conductive material having needle-pointed ends for providing a high potential gradient to ionize particle components of a gas passing there-through said ionizing element being connected to the said seventh electrical coupling means to produce said high potential gradient when supplied with charge from a high voltage source through said seventh electrical coupling means.
A slot opening allows air and ionic charges to travel freely between the said ionizing element and the outside ambient of the housing enclosure;
A mechanical coupling means assembled to the said mechanical mounting means of the said housing enclosure to provide carrying means of the said subcompact breath cleaner ionization module for the said user.

37. The apparatus of claim 36, wherein said the said conductive collector element attracts the airborne charged matters introduced by the said ionization process with the said input of the said conductive collector element is connected to a source with opposite electrically charged with reference to the electrical polarity of the said ionizing element.

38. The apparatus of claim 37, wherein said the method of using a conductive collector element to attract airborne charged matters introduced by ionization process with the said input of the said conductive collector element is connected to a source with opposite electrically charged with reference to the electrical polarity of the said ionizing element, in a subcompact breath cleaner ionization module.

39. The apparatus of claim 36, wherein said the said ionizing element generates positive ionic charges.

40. The apparatus of claim 36, wherein said the said ionizing element generates negative ionic charges.

41. The apparatus of claim 36, wherein said the said seventh electrical coupling means is a quick disconnect connector which is defined as disconnecting process without requirement of removal of mechanical fastener.

42. The apparatus of claim 36, wherein said the said electrically conductive material having needle-pointed ends may be substituted with conductive metal-coated fine non-metallic filaments.

43. The apparatus of claim 36, wherein said the method of using an ionizing element in a human body carrying subcompact breath cleaner ionization module to ionize particle components of a gas passing there-through the said ionizing element.

44. The apparatus of claim 43, wherein said the said ionizing element generates positive ionic charges.

45. The apparatus of claim 43, wherein said the said ionizing element generates negative ionic charges.

46. The apparatus of claim 1, wherein said the said main power supply module of a subcompact modular ionic breath cleaner which supplies high voltage source to the said subcompact breath cleaner ionization module to ionize particle components of a gas passing there-through the ionizing element of the said subcompact breath cleaner ionization module is comprised of
A housing enclosure;
A belt mounting mechanism support by the said housing enclosure for user's belt mounting;
A battery holder having an output and is supported by the said housing provides space for the battery as the power source for the said subcompact modular ionic breath cleaner;
A PCBA (printed circuit board assembly) having an input and an output with the said input connected to the said output of the said battery holder is functioned to transform the said battery power into high voltage source at the said output;
An eighth electrical coupling means connected to the said output of the said PCBA for accepting the said second electrical coupling means of the said connecting cable for the transmission of electric potential energy all the way to the said input of the subcompact breath cleaner ionization module;
A power on-off switch;
A ninth electrical coupling means connected to the said PCBA and serves as the receptacle for external power supply;
An indicating means connected to the said PCBA and supported by the said housing enclosure for the indication of the power status of the system.

47. The apparatus of claim 46, wherein said the said PCBA of the said power supply module of a subcompact modular ionic breath cleaner comprises:
A direct current DC power supply stage;
An oscillator stage powered by said direct current power supply;
A step-up transformer having a primary and at least one secondary winding, said primary winding forming an output of said oscillator stage;
A voltage multiplier stage having an input and an output with the said input of the said voltage multiplier being connected to the output of the oscillator stage; and the said output of the said voltage multiplier forms an output with high voltage power supply for supporting external device of a subcompact breath cleaner ionization module.

48. The apparatus of claim 47 wherein said the method of using an oscillator circuit to convert a DC power source into a pulsating/oscillating DC power source as the input power source to a step-up transformer circuit of a high voltage power supply source of a power supply module of a subcompact modular ionic breath cleaner.

49. The apparatus of claim 47 wherein said the method of using a step-up transformer with at least one primary winding and at least one secondary winding to transform a pulsating/oscillating DC power source input to a higher voltage output of a high voltage power supply source of a power supply module of a subcompact modular ionic breath cleaner.

50. The apparatus of claim 47 wherein said the method of using a voltage multiplier circuit to multiply the input voltage generated by the said step-up transformer to a high voltage output of a high voltage power supply source of a power supply module of a subcompact modular ionic breath cleaner.
The voltage multiplier circuit is defined as using multiple stages of capacitor and diode cascade circuit to increase the said input voltage to an output voltage of at least 1 time of the said input voltage potential.

51. The apparatus of claim 47 wherein said the electronic components of the said voltage multiplier PCBA are encapsulated in encapsulation resin to allow the spaces between components to be smaller and will not be electrically shorted.

52. The apparatus of claim 51 wherein said the method of using encapsulation with encapsulation resin process on the components of the PCBA of a power supply module of a subcompact modular ionic breath cleaner.
